(19) United States
(12) Patent Application Publication
(10) Pub. No.: US 2026/0351221 A1
(43) Pub. Date: Nov. 5, 2026

(54) STRINGED INSTRUMENT

(71) Applicant: HOSHINO GAKKI CO., LTD., Nagoya (JP)

(72) Inventor: Osamu YOSHIMURA, Nagoya (JP)

(21) Appl. No.: 19/369,332

(22) Filed: Oct. 27, 2025

(30) Foreign Application Priority Data
May 2, 2025 (JP) 2025-076943

(51) Int. Cl. G10D 3/13; G10D 1/08; G10D 3/04; G10D 3/14

(52) U.S. Cl. CPC G10D 3/13; G10D 1/085; G10D 3/04; G10D 3/14

(57) ABSTRACT

An electric guitar includes a string-rear-end fixing portion that fixes a rear end of a string, a bridge having a base unit provided on a base plate so as to be slidable in a stretching direction of the string, and a saddle that supports the string on the base unit. The base plate includes a string-through-body hole through which a through-body string is drawn into the string-rear-end fixing portion of the body. The base unit includes an elongated string passage hole that allows the string to pass through the string-through-body hole. The base unit includes a tailpiece used to fix a rear end of the string. The base unit is configured to fix the rear end of the string instead of the string-rear-end fixing portion.

### CROSS-REFERENCE TO RELATED APPLICATIONS

This application is based upon and claims the benefit of priority from Japanese Patent Application No. 2025-076943, filed on May 2, 2025, the entire contents of which are incorporated herein by reference.

### BACKGROUND

### 1. Field

The present disclosure relates to a stringed instrument including a bridge.

### 2. Description of Related Art

Examples of stringed instruments provided with a bridge include electric guitars and electric basses. In these stringed instruments, the front ends of multiple strings are fixed to, for example, pegs on a neck. The rear ends of the strings are supported by a bridge fixed to the body. In this manner, the strings are stretched. The string heights and string lengths are adjusted at the bridge, for example, based on expansion, contraction, or warping of the neck or body or based on the characteristics of the strings.

Various types of bridges are known. In recent years, individual-type bridges have been proposed in which each string is provided with a separate and independent bridge so that the strings are not affected by each other.

For example, FIG. 17 is a plan view showing an overall configuration of an electric bass 101 including bridges 105, as disclosed in JP2000-214856A.

As shown in FIG. 17, the electric bass 101 includes four strings 190 stretched. One end of each string 190 is supported by the corresponding bridge 105 fixed to a body 104. The other end of each string 190 is wound around a peg 121 attached to a head 102.

The bridges 105 are used to finely adjust the string heights and lengths, and support and fix the strings 190. As shown in FIGS. 18-20, the bridges 105 each include a bridge body 105a and a saddle 170. Each bridge 105 is an individual-type bridge independent from the other bridges 105.

Each bridge body 105a is fixed to the body 104. A longitudinal adjustment screw 134 is inserted through the rear part of the bridge body 105a. A user rotates the longitudinal adjustment screw 134 to move a saddle 170 accommodated in the bridge body 105a forward or backward, thereby adjusting the string length.

The lower part of each bridge body 105a includes a hanging portion 124. One end of the string 190 is fixed to the hanging portion 124.

Two vertical adjustment screws 137, 138 are threaded into the front part of the saddle 170. The vertical adjustment screws 137, 138 support the saddle 170 within the bridge body 105a to allow the saddle 170 to move vertically, with their lower ends held in contact with the upper surface of the bridge body 105a.

For adjustment of the string length, the longitudinal adjustment screw 134 is turned to adjust the longitudinal position of the saddle 170 within the bridge 105. For adjustment of the string height, the vertical adjustment screws 137 and 138 are turned to adjust the vertical position of the saddle 170 within the bridge 105.

Although not shown, in the stringed instruments disclosed in US2005/0150347A1 and US2006/0162528A1, the saddle is configured to support each string fixed to the inside of the body and to adjust the string length and string height by means of screws in the same manner as the stringed instrument disclosed in JP2000-214856A.

The individual-type bridges disclosed in these publications allow the length and height of each string to be adjusted independently without being affected by the other strings.

In recent years, in addition to standard six-string guitars, electric guitars having seven or more strings have come into use. Likewise, in addition to standard four-string electric basses, electric basses having five or more strings have come into use. In such cases, in order to expand the tonal range, strings having significantly different thicknesses may be used simultaneously on a single stringed instrument.

In such cases, for relatively thick bass strings, through-body stringing is preferred, in which the rear end of a string is fixed directly to a portion of the body via the rear side of the bridge. In this fixing method, a string is first bent toward the inside of the body and then fixed at a fixing portion embedded in the front surface of the body. Alternatively, a string may be fixed to the rear side of the body at a fixing portion that extends through the body. A bridge that directly fixes a through-body string to the body allows the string to be stably fixed even under relatively low tension. The above-mentioned publications disclose such through-body string fixing configurations.

For relatively thin treble strings, it is preferable to fix the strings to the front surface of the bridge using a tailpiece.

As such, in stringed instruments such as multi-string guitars, it is desirable to enable strings to be stretched using methods corresponding to the types of strings. However, conventionally, only one stringing method can be used in a given stringed instrument.

It is an objective of the present disclosure to provide a stringed instrument that enables proper handling of strings according to string types.

### SUMMARY

This Summary is provided to introduce a selection of concepts in a simplified form that are further described below in the Detailed Description. This Summary is not intended to identify key characteristics or essential characteristics of the claimed subject matter, nor is it intended to be used as an aid in determining the scope of the claimed subject matter.

A stringed instrument according to an aspect of the present disclosure includes a body, a string supported by the body, a string-rear-end fixing portion provided on the body and configured to fix a rear end of the string, a bridge including a base plate fixed to the body and a base unit provided on the base plate so as to be slidable in a stretching direction of the string, a saddle accommodated in a cavity provided in the base unit, the saddle being configured to support the string, a string height adjustment mechanism configured to adjust raising and lowering of the saddle, and an intonation adjustment mechanism configured to slide the base unit on the base plate in the stretching direction. The base plate includes a string-through-body hole through which the string, supported by the saddle, is drawn into the string-rear-end fixing portion of the body. The base unit includes a string passage hole that allows the string, supported by the saddle, to pass through the string-through-body hole. The base unit includes a tailpiece configured to fix a rear end of the string. The base unit is configured to fix the rear end of the string instead of the string-rear-end fixing portion.

Other features and aspects will be apparent from the following detailed description, the drawings, and the claims.

### BRIEF DESCRIPTION OF THE DRAWINGS

FIG. 1 is a perspective view of a guitar according to the present embodiment.

FIG. 2 is a perspective view of the rear surface of the guitar.

FIG. 3 is a left side view of the guitar.

FIG. 4 is a partial cross-sectional view taken along line 4-4 in FIG. 3.

FIG. 5 is a perspective view showing the area around the bridge of the guitar.

FIG. 6 is a perspective view of the bridge accommodation portion with the bridge omitted.

FIG. 7 is a perspective view of the bridge.

FIG. 8 is a perspective view of the bridge as viewed from an angle different from the angle shown in FIG. 7.

FIG. 9 is an exploded perspective view of the bridge.

FIG. 10 is a plan view of the bridge.

FIG. 11 is a cross-sectional view taken along line 11-11 in FIG. 10.

FIG. 12 is a cross-sectional view taken along line 12-12 in FIG. 10.

FIG. 13 is a rear view of the bridge.

FIG. 14 is a cross-sectional view taken along line 14-14 in FIG. 13.

FIG. 15 is a diagram illustrating movement of the base unit relative to the base plate.

FIG. 16 is a diagram illustrating a state in which the base unit is moved from the position shown in FIG. 15.

FIG. 17 is a perspective view showing a guitar of the prior art.

FIG. 18 is a perspective view showing bridges of the guitar.

FIG. 19 is an exploded perspective view of a bridge.

FIG. 20 is a partial cross-sectional view taken along line 20-20 in FIG. 18.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

In this specification, “at least one of A and B” should be understood to mean “only A, only B, or both A and B.”

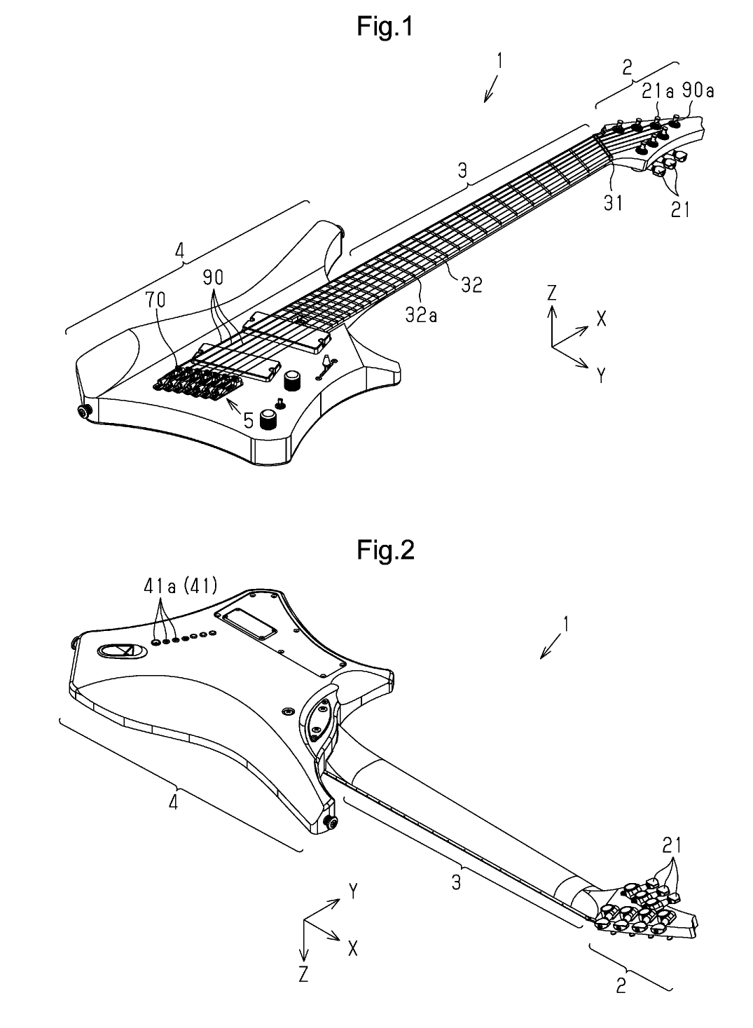

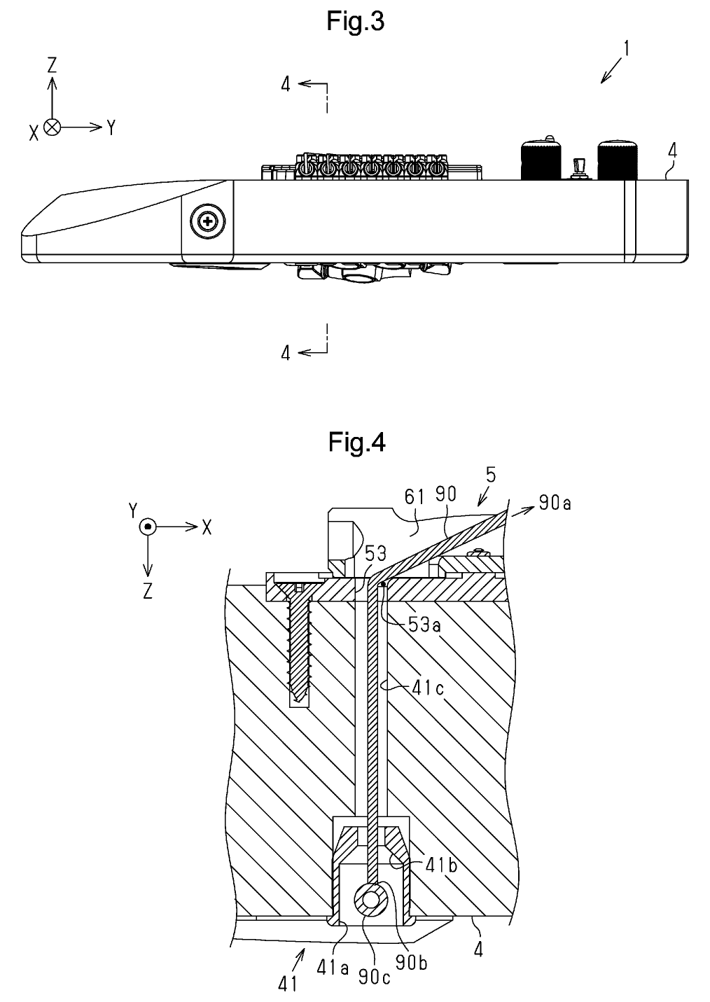

An embodiment of a stringed instrument according to the present disclosure will now be described with reference to a guitar 1. The guitar 1 is a seven-string electric guitar. The present disclosure is not to be construed as being limited to the present embodiment. Hereinafter, in describing the guitar 1, X-, Y-, and Z-directions are defined as shown in FIG. 1.

### Overview of the Present Embodiment

As shown in FIG. 1, the guitar 1 includes a substantially trapezoidal body 4, a rod-shaped neck 3 extending from the body 4 in the X-direction, and a head 2 disposed at a front end of the neck 3. To facilitate understanding, the portion of the guitar 1 closer to the head 2 is referred to as the front end, and the portion of the guitar 1 closer to the body 4 is referred to as the rear end. The body 4 has a front surface to which a bridge 5 is attached, and a rear surface opposite the front surface. The body 4 has a width in the Y-direction.

Each string 90 has a front end 90a wrapped around and fixed to a string post 21a of a peg 21 of the head 2.

The rear end 90b of each string 90 is fixed using the following two methods. One is referred to as string-through-body stringing, in which the string 90 is fixed to a string-rear-end fixing portion 41 provided on the rear surface of the body 4, as shown in FIG. 2. In this case, as shown in FIG. 4, the front end 90a of the string 90 is inserted from an opening 41a of the string-rear-end fixing portion 41 on the rear surface of the body 4. Then, the string 90 that has passed through a string introduction passage 41c of the body 4 is pulled out onto the bridge 5. The string 90 is wound around the peg 21 through a string passage hole 61 of a base unit 60 and a saddle 70. A ball end 90c is attached to the rear end 90b of the string 90. The rear end 90b of the string 90 is fixed to the string-rear-end fixing portion 41 via the ball end 90c. The string passage hole 61 is elongated such that the string 90 does not interfere with a wall of the string passage hole 61 even when the base unit 60 slides for string length adjustment.

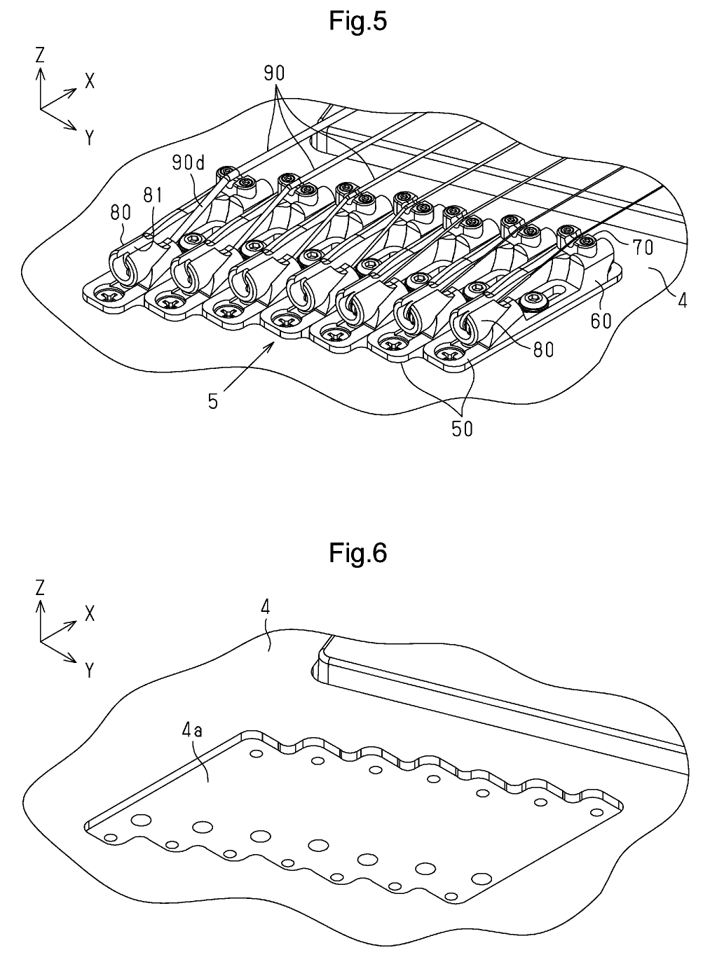

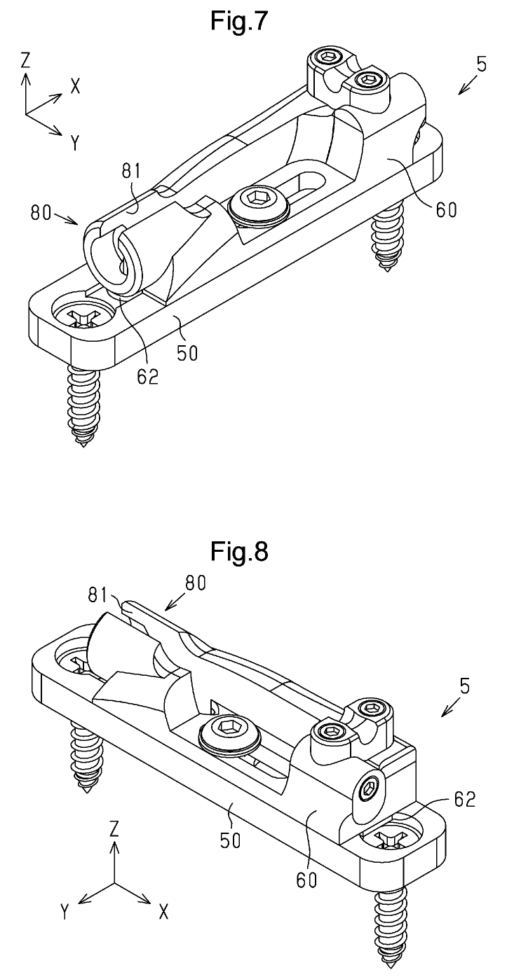

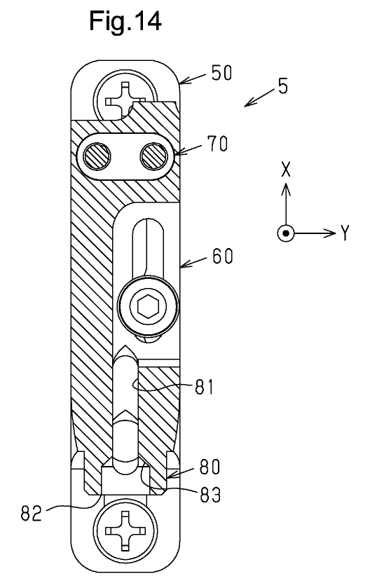

The other method of fixing the rear end 90b of each string 90 is to fix the string 90 with the tailpiece 80, which is provided at a rear end portion of the bridge 5. Although details will be described later, as shown in FIG. 5, an intermediate portion 90d of the string 90 is inserted into a string introduction groove 81 of the tailpiece 80, which is shown in FIGS. 7 and 8. Then, when the string 90 is wound around the peg 21 (FIG. 1) and pulled in the X-direction, the ball end 90c of the rear end 90b of the string 90 is hooked and fixed to a string-rear-end fixing portion 83 (FIG. 14), which is a ball end hooking portion, in an opening 82.

In the present embodiment, for each string 90, it is possible to selectively fix a through-body string 90 to the string-rear-end fixing portion 41, or fix the string 90 to the bridge 5 using the tailpiece 80. As shown in FIG. 5, the rear end 90b of each of the first to third strings 90 is fixed to a corresponding tailpiece 80. The rear end 90b of each of the fourth to seventh strings 90 is fixed to a corresponding string-rear-end fixing portion 41 as a through-body string.

### CONFIGURATION OF THE PRESENT EMBODIMENT

### Guitar 1

As shown in FIG. 1, the guitar 1 is a stringed instrument generally made of wood, includes a body 4, and is configured to support and stretch the strings 90 on the body 4. Hereinafter, a seven-string electric guitar will be described as an example. The stringed instrument may be an electric bass. The electric guitar may include seven or more strings, and the electric bass may include five or more strings. The stringed instrument is not limited to the electric guitar or the electric bass.

### Head 2

As shown in FIG. 1, the guitar 1 includes a head 2, and includes pegs 21 corresponding to the number of strings 90 (seven in the present embodiment). Each peg 21 is configured to wind the front end 90a of the corresponding string 90 around the string post 21a so as to fix the front end 90a in place. A user winds the string 90 with the peg 21 to adjust the tension of the string 90, thereby performing tuning.

### Neck 3

The neck 3 is a rod-shaped portion disposed between the body 4 and the head 2. The front surface of the neck 3 includes a gently curved fingerboard 32. The fingerboard 32 includes frets 32a arranged at predetermined positions in a direction that is orthogonal to the strings 90. In a conventional six-string guitar, the frets 32a are generally arranged at intervals that are approximately parallel to one another. In the seven-string guitar of the present embodiment, the thicknesses of the strings 90 significantly differ from one another. Accordingly, the length of a bass-side string 90 (located in the upper left in FIG. 1) is longer, while the length of a treble-side string 90 (located in the lower right in FIG. 1) is shorter. This results in wider spacing between the frets 32a on the bass side and narrower spacing on the treble side.

Each string 90 is stretched between a nut 31, which is disposed at the upper end of the neck 3, and the saddle 70 of the bridge 5 of the body 4 such that the string 90 can vibrate. By adjusting the height of the string 90 (hereinafter referred to as the string height), the distance between the string 90 and the frets 32a changes, thereby affecting the ease of pressing the string 90 and the degree of interference with the frets 32a. Particularly on the bass side, the amplitude of the string 90 increases, making interference with the frets 32a more likely to occur. The string height is adjusted by a string height adjustment mechanism, which will be described later.

### Body 4

As shown in FIG. 5, the bridge 5 is disposed on the body 4. The bridge 5 includes base plates 50 fixed to the body 4. The base plates 50 are flat and made of metal.

As shown in FIG. 6, the body 4 includes a bridge accommodation portion 4a. The bridge accommodation portion 4a is a recess provided in the body 4. The bridge accommodation portion 4a has a shape conforming to the contour of the base plate 50 as viewed in the string height direction. The base plate 50 is accommodated in the bridge accommodation portion 4a without a gap, but may alternatively be mounted on a flat surface of the body 4.

### Bridge 5

As shown in FIGS. 7 and 8, the bridge 5 includes the base plate 50 fixed to the body 4 and the base unit 60. The base unit 60 is provided on the base plate 50 so as to be slidable in the stretching direction of the string 90.

As shown in FIG. 5, the bridge 5 refers to an independent-type bridge assembly in which a separate bridge for each string 90 is provided independently. In the individual- bridge configuration, greater flexibility is provided not only in the placement of the bridge 5 but also in the handling tailored to each string 90. In particular, greater flexibility is provided in positioning the bridge 5 between the bass side, where the string length is longer, and the treble side, where the string length is shorter.

### Base Plate 50

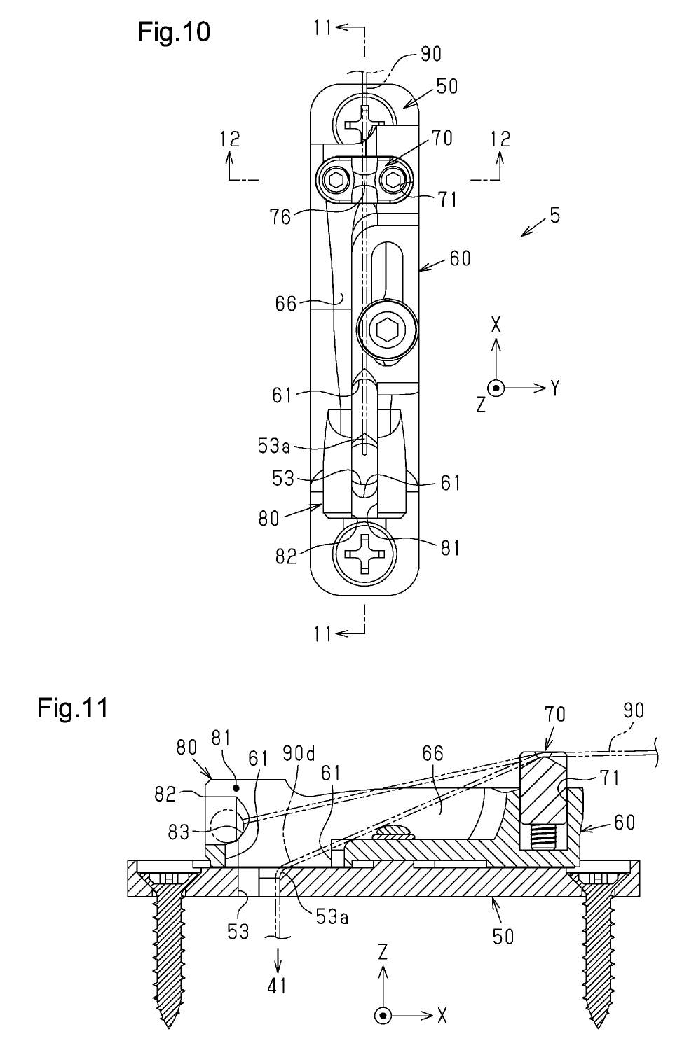

Referring to FIG. 10, the base plate 50 is a flat metal plate made of, for example, stainless steel. The base plate 50 has the shape of a rectangle extending in the stretching direction of the string 90 in plan view, and includes rounded corners. Front and rear end portions of the base plate 50 each include a body fixing screw hole 55. The body fixing screw hole 55 includes a counterbore that accommodates the head of a body fixing screw 54. This prevents the head of the body fixing screw 54 from protruding from the base plate 50.

Further, the base plate 50 includes front and rear slide rails 51 extending respectively from the front and rear counterbores to the vicinity of the center of the base plate 50. Each slide rail 51 is a groove-shaped recess having a rectangular cross-section.

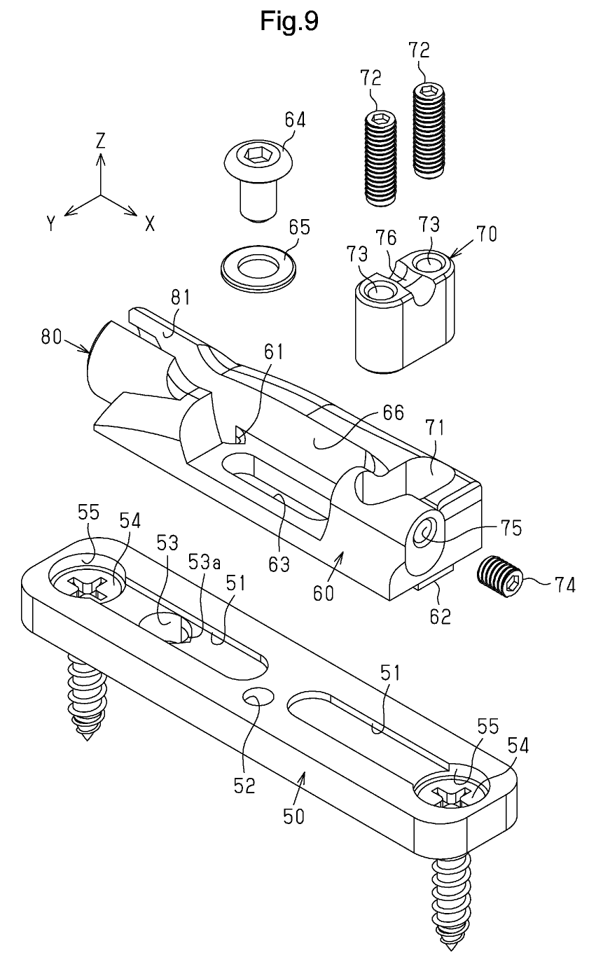

As shown in FIG. 9, a string-through-body hole 53 is provided at a substantially central portion of the rear slide rail 51. The string 90 supported by the saddle 70 passes through the string-through-body hole 53 and is drawn into the string-rear-end fixing portion 41, which is on the rear side of the body 4.

As shown in FIGS. 4 and 11, a rounded portion 53a is provided at a part of the string-through-body hole 53 that is in contact with the intermediate portion 90d of the string 90 supported by the saddle 70. The rounded portion 53a has a curvature that is set to a value at which the string 90 fixed to the string-rear-end fixing portion 41 (FIG. 4) does not bend beyond a predetermined curvature at a part of the rounded portion 53a where the string 90 is in contact with a wall of the string-through-body hole 53. That is, the curvature of the rounded portion 53a is set to a relatively large value such that the string 90 supported by the saddle 70 is bent at a gentle angle at a part where the string 90 is in contact with the wall of the string-through-body hole 53 and is introduced into the string introduction passage 41c. The curvature of the rounded portion 53a is set such that the string 90 does not break or deteriorate depending on the thickness and material of the string 90 to be used.

As shown in FIG. 9, a base-unit-fixing screw hole 52 is provided at a substantially central portion of the base plate 50. A base-unit-fixing screw 64 used to fix the base unit 60 is threaded into the base-unit-fixing screw hole 52.

### Base Unit 60

As shown in FIGS. 7-9, the base unit 60 is a box-shaped metal block made of, for example, stainless steel. Each of the front and rear parts of the lower surface of the base unit 60 includes a slider 62. The slider 62 extends in the longitudinal direction of the base unit 60 and has a rectangular cross-section. As shown in FIG. 9, the width of the slider 62 corresponds to the width of the slide rail 51, which is disposed on the base plate 50. This allows the slider 62 to move in the stretching direction of the string 90 while being guided by the slide rail 51 on the base plate 50.

The base unit 60 includes a guide groove 63 extending in the stretching direction of the string 90. The base-unit-fixing screw 64 is passed through the guide groove 63 of the base unit 60 via a washer 65 and then threaded into the base-unit-fixing screw hole 52 of the base plate 50. Thus, movement of the shaft of the base-unit-fixing screw 64 is guided by the guide groove 63 of the base unit 60. As a result, the base-unit-fixing screw 64 is guided by the guide groove 63 together with the sliders 62 respectively sliding on the slide rails 51, so that the base unit 60 slides on the base plate 50 in the stretching direction of the string 90. By tightening the base-unit-fixing screw 64, the base unit 60 is pressed against the base plate 50 by the head of the base-unit-fixing screw 64. As a result, the movement of the base unit 60 on the base plate 50 is restricted. This enables the adjusted intonation of the string 90 to be maintained.

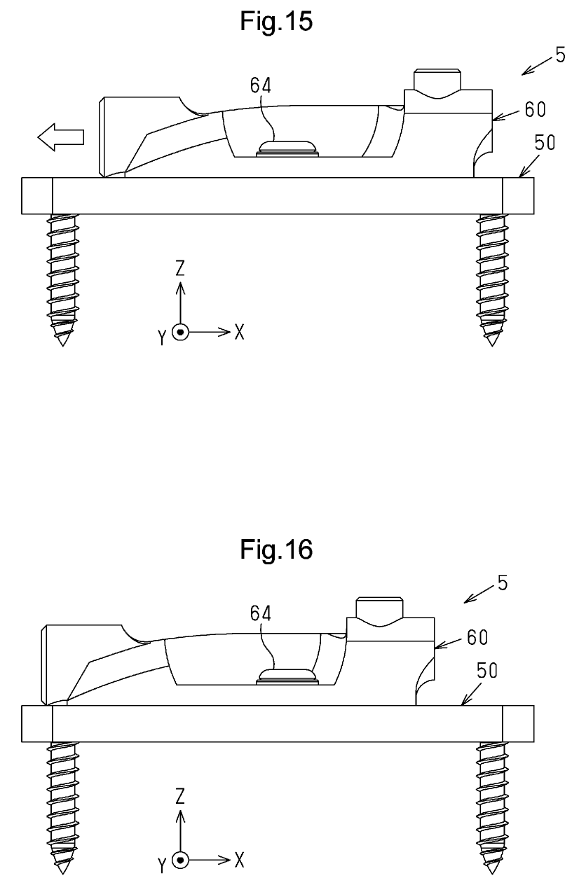

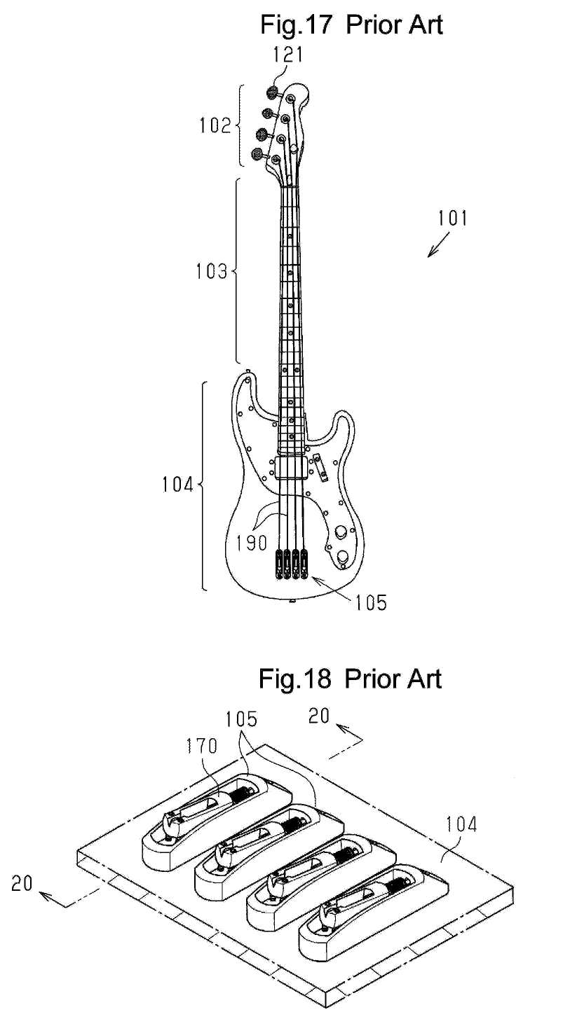

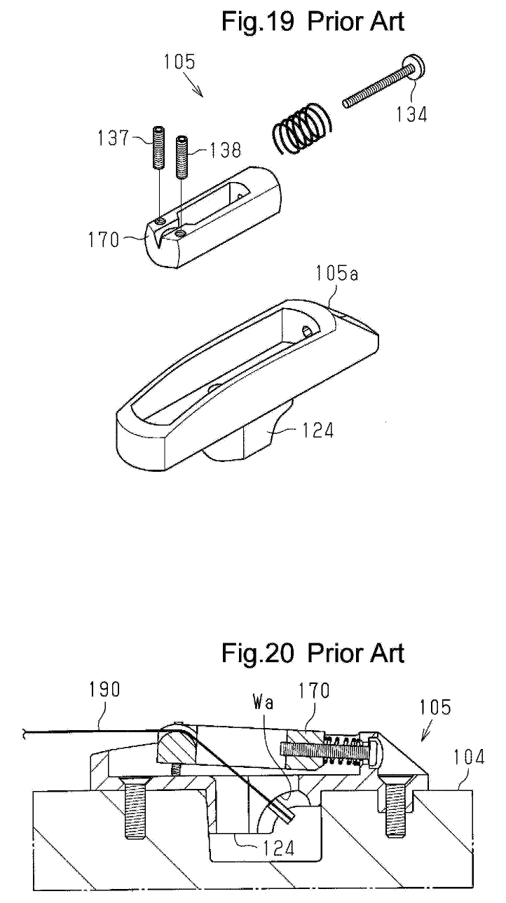

As shown in FIG. 11, the base unit 60 includes the string passage hole 61. The string 90 supported by the saddle 70 is passed through the string passage hole 61 and the string-through-body hole 53 of the base plate 50. It is desired that the string 90 be stretched between the saddle 70 and the rounded portion 53a of the string-through-body hole 53 without the base unit 60 interfering with the string 90. The base unit 60 is moved relative to the base plate 50 when intonation adjustment for the string 90 is performed (see FIGS. 15 and 16). In order to prevent the string 90 from interfering with the wall of the string passage hole 61 even when the base unit 60 is slid relative to the base plate 50, the string passage hole 61 is shaped as an elongated hole extending in the stretching direction of the string 90. This allows the intonation of a through-body string 90 to be adjusted without the base unit 60 interfering with the string 90.

The rear slider 62, shown in FIG. 7, surrounds the periphery of the string passage hole 61, shown in FIG. 10. This allows for placement of the slider 62 on the base unit 60 even if the base unit 60 includes the string passage hole 61. Further, uniform application of the tension of the string 90 to the entire rear slider 62 allows for stable orientation of the base unit 60 relative to the base plate 50.

As shown in FIGS. 9-11, the base unit 60 includes a side wall 66. The base unit 60 includes a cavity 71 that accommodates the saddle 70 on its front end, and includes the tailpiece 80 on its rear end. Further, the central portion of the base unit 60 includes the string passage hole 61. The base unit 60 has a reduced strength due to the arrangement of the string passage hole 61 while receiving a relatively large force from the stretched string 90. For this reason, the base unit 60 includes the side wall 66 at a position between the cavity 71 and the tailpiece 80 where the side wall 66 does not interfere with the string 90 passing through the string passage hole 61. The side wall 66 extends in the longitudinal direction of the base unit 60 and the string height direction.

### String-Rear-End Fixing Portion 41

As shown in FIG. 4, the string-rear-end fixing portion 41 fixes the rear end 90b of the string 90 to the body 4. The string 90 is introduced into the opening 41a of the string-rear-end fixing portion 41 from the rear surface of the body 4 as shown in FIG. 2, passed through the string-through-body hole 53 of the bridge 5, and then pulled up toward the front surface of the body 4. In a state in which the front end 90a of the string 90 passes through the string passage hole 61 of the base unit 60 on the front side of the body 4, the front end 90a is wound by the peg 21 of the head 2 while being supported by the saddle 70 and the nut 31 (FIG. 1) as shown in FIG. 5. Thus, as shown in FIG. 4, the rear end 90b of the string 90 is hooked and fixed to a hooking portion 41b via the ball end 90c.

### Tailpiece 80

As shown in FIGS. 7-9, the base unit 60 includes the tailpiece 80 at its rear part. The tailpiece 80 is used to fix the rear end 90b of the string 90. In the present embodiment, instead of using the string-rear-end fixing portion 41 to fix the rear end 90b of a through-body string 90 to the body 4, the tailpiece 80 may be used to fix the rear end 90b of the string 90 to the bridge 5.

As shown in FIG. 10, the tailpiece 80 is provided at a rear end portion of the base unit 60. The tailpiece 80 has a cylindrical shape with a center line extending in the stretching direction of the string 90, which is indicated by the double-dashed line. The upper part of the tailpiece 80 includes a slit-shaped string introduction groove 81 extending in the stretching direction of the string 90.

As shown in FIGS. 11 and 14, the tailpiece 80 includes the string-rear-end fixing portion 83. The rear end 90b of the string 90 supported by the saddle 70 is introduced from the string introduction groove 81 and then locked at the string-rear-end fixing portion 83. The rear part of the string-rear-end fixing portion 83 has a space. The space accommodates the ball end 90c of the string 90 and opens rearward. The front part of the string-rear-end fixing portion 83 has a reduced inner diameter such that the string 90 can pass through and the string-rear-end fixing portion 83 can hook the ball end 90c of the string 90. This allows the tailpiece 80 to fix the ball end 90c of the rear end 90b of the string 90.

### Saddle 70

As shown in FIG. 10, the front part of the base unit 60 includes a track-shaped cavity 71 as viewed in the string height direction. The saddle 70 is accommodated in the cavity 71 with a slight gap between the wall of the cavity 71 and the saddle 70. The saddle 70 is made of metal. The saddle 70 has a track shape similar to the cavity 71 as viewed in the string height direction. The saddle 70 is accommodated in the cavity 71 so as to be slidable in the string height direction.

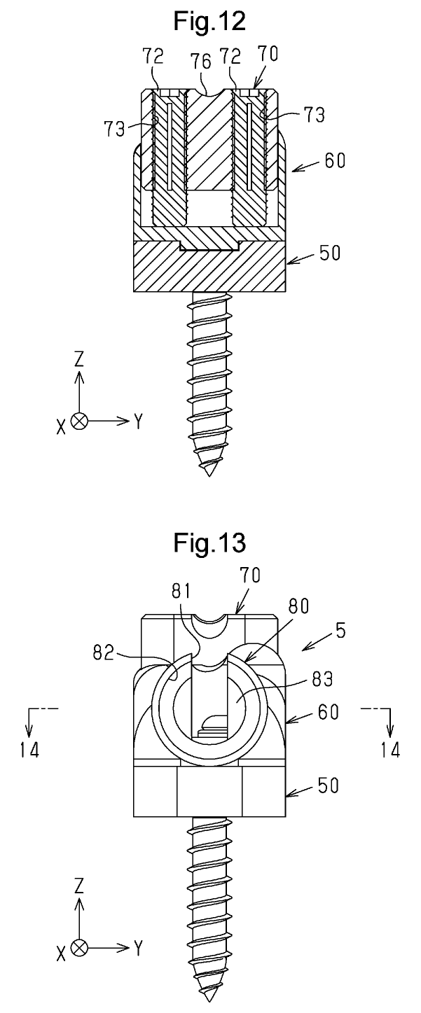

As shown in FIGS. 9 and 12, the saddle 70 includes two string height adjustment screw holes 73. Two string height adjustment screws 72 are threaded into the two string height adjustment screw holes 73 from above, respectively. Each string height adjustment screw 72 has a front end that protrudes from the lower end of the saddle 70 to bring the front end into contact with the bottom surface of the cavity 71, thereby maintaining the height of the saddle 70 relative to the base unit 60. The string height can be adjusted by turning the string height adjustment screw 72. The two string height adjustment screws 72 are provided such that the string 90 is disposed therebetween. This arrangement allows the string height to be adjusted while the string 90 remains stretched. Further, the inclination of the saddle 70 about the stretching direction can be adjusted by adjusting the amount by which each string height adjustment screw 72 is threaded into the corresponding string height adjustment screw hole 73.

As shown in FIG. 9, a saddle fixing screw 74 is threaded into a saddle fixing screw hole 75 in a direction that is orthogonal to the sliding direction of the saddle 70. Turning the saddle fixing screw 74 restricts the sliding of the saddle 70 in the cavity 71. That is, it is ensured that the saddle 70 is fixed in the cavity 71 by the saddle fixing screw 74. This effectively suppresses vibration of the saddle 70 during performance of the guitar 1.

The saddle 70 is made of metal having higher slidability than the stainless steel base unit 60, such as brass. Accordingly, the coefficient of friction between a string support portion 76 of the saddle 70 and the string 90 during tuning is reduced. This facilitates sliding of the string 90 during tuning and thus protects the string 90 from friction with the saddle 70. The saddle 70 of the guitar 1 is replaceable. This allows the user to use various types of saddles 70 having different materials, heights, and curvatures of the string support portion 76 depending on the type of the string 90.

### OPERATION OF THE PRESENT EMBODIMENT

### The guitar 1 has the following operation.

### Intonation Adjustment Mechanism

The guitar 1 includes the intonation adjustment mechanism used to slide the base unit 60 on the base plate 50 in the stretching direction of the strings 90. The intonation adjustment mechanism includes the slide rails 51 and the sliders 62, which are provided on the base plate 50 and the base unit 60, respectively. The intonation adjustment mechanism is configured to slide the base unit 60 in the stretching direction relative to the base plate 50. With this configuration, the string length is adjusted by changing the distance from the saddle 70, which is disposed on the base unit 60, to the nut 31 (FIG. 1).

In the intonation adjustment, first, in the state illustrated in FIG. 15, the base-unit-fixing screw 64 is loosened using a screwdriver (not shown). In this state, as shown in FIG. 10, the string 90 is stretched at a position offset from the base-unit-fixing screw 64. This allows the user to loosen the base-unit-fixing screw 64 and move the base unit 60 relative to the base plate 50 without interference between the screwdriver and the string 90. In the example shown in FIGS. 15 and 16, the base unit 60 is moved from the state shown in FIG. 15 toward the rear end, that is, in a direction in which the string length increases. The front and rear sliders 62 and the corresponding front and rear slide rails 51 allow the base unit 60 to slide on the base plate 50 while restricting its movement direction to the stretching direction of the string 90. Simultaneously, the shaft of the base-unit-fixing screw 64 is guided by the guide groove 63 and slides in the guide groove 63 while restricting the movement direction to the stretching direction of the string 90. Then, the user adjusts the pitch of each string 90 such that the pitch of the tone produced by pressing the 12th fret of the string 90 matches the pitch of the harmonic generated at the 12th fret.

For the intonation adjustment of the present embodiment, the same method can be used for either the method of fixing a through-body string 90 using the string-rear-end fixing portion 41 or the method of fixing a string 90 at the bridge 5 using the tailpiece 80. In particular, when intonation adjustment is performed to fix a through-body string 90, the string-through-body hole 53 of the base plate 50 may be misaligned with the string passage hole 61 of the base unit 60. In the present embodiment, the string passage hole 61 is elongated to avoid interference between its wall and the string 90. This allows the string 90 to pass from the saddle 70 to the string-through-body hole 53 without interfering with the wall of the string passage hole 61.

After intonation adjustment for the string 90 is completed, the base-unit-fixing screw 64 is tightened using the screwdriver. This enables the adjusted intonation to be maintained.

### String Height Adjustment Mechanism

The guitar 1 includes a string height adjustment mechanism that is configured to adjust the raising and lowering of the saddle 70. The saddle 70 is raised and lowered to adjust the string height. As shown in FIGS. 10 and 12, each string height adjustment screw 72 is turned to raise and lower the saddle 70, thereby adjusting the string height. The two string height adjustment screws 72 are provided such that the string 90 is disposed therebetween. To adjust the string height, the saddle fixing screw 74 is first loosened using the screwdriver. Then, with the string 90 stretched, each string height adjustment screw 72 is turned using the screwdriver to adjust the string height.

As shown in FIG. 12, the saddle 70 is accommodated in the cavity 71, which extends in the string height direction. Further, the saddle 70 is accommodated in the cavity 71 so as to be slidable in the string height direction. Thus, the structure of the string height adjustment mechanism has little influence on the intonation adjustment.

After the string height adjustment is completed, the saddle fixing screw 74 shown in FIG. 9 is tightened using the screwdriver. In this state, the saddle 70 is pressed against the inner wall of the cavity 71 on the rear side. Additionally, the curved surface of the saddle 70 is in contact with the curved wall surface of the cavity 71, so that the saddle 70 is fixed at a predetermined position in the cavity 71 without rattling.

### ADVANTAGES OF THE PRESENT EMBODIMENT

The stringed instrument of the present embodiment has the advantages described below.
(1) The guitar 1 enables proper handling of the strings 90 depending on the type of string 90.
(2) The bridge 5 includes the base unit 60, which is provided on the base plate 50 so as to be slidable in the stretching direction of each string 90. The saddle 70 is accommodated in the cavity 71 of the base unit 60 to support the string 90. This allows for intonation adjustment to be readily performed only by sliding the base unit 60.
(3) The base plate 50 includes the string-through-body hole 53. The string 90 supported by the saddle 70 is passed through the string-through-body hole 53 and then drawn into the string-rear-end fixing portion 41 on the rear side of the body 4. The base unit 60 includes the string passage hole 61. The string 90 supported by the saddle 70 passes through the string passage hole 61 and the string-through-body hole 53. The string passage hole 61 is shaped as an elongated hole extending in the stretching direction of the string 90 to prevent the string 90 from interfering with the wall of the string passage hole 61 when the base unit 60 is slid relative to the base plate 50. This allows the intonation of a through-body string 90 to be adjusted without interference with the base unit 60.
(4) The base unit 60 includes the tailpiece 80, which is used to fix the rear end 90b of the string 90. This configuration allows the tailpiece 80 to be used to fix the rear end 90b of the string 90 to the bridge 5, instead of using the string-rear-end fixing portion 41 to fix the rear end 90b of a through-body string 90. Thus, within a single guitar 1, a method for fixing the rear end 90b of the string 90 is selectively performed according to the type of string 90.
(5) The intonation adjustment mechanism includes the slide rails 51 and the sliders 62, which are provided on the base plate 50 and the base unit 60, respectively. The intonation adjustment mechanism is configured to slide the base unit 60 in the stretching direction of the string 90 relative to the base plate 50. The base unit 60 includes the guide groove 63, which extends in the stretching direction of the string 90. The base-unit-fixing screw 64 is threaded into the base-unit-fixing screw hole 52 of the base plate 50. Thus, the movement of the shaft of the base-unit-fixing screw 64 is guided by the guide groove 63. As a result, the base unit 60 is movable in the stretching direction of the string 90 relative to the base plate 50. This allows the base unit 60 to stably and accurately move in the stretching direction of the string 90 during intonation adjustment.
(6) Tightening the base-unit-fixing screw 64 restricts the movement of the base unit 60 on the base plate 50. This enables the adjusted intonation of the string 90 to be maintained.
(7) The rear slider 62 is provided to surround the peripheral edge of the string passage hole 61. This allows the base unit 60 to stably slide on the base plate 50 without interfering with the string 90.
(8) The string-rear-end fixing portion 41 fixes the rear end 90b of the string 90 introduced from the rear side of the body 4. This allows even bass strings 90 to be stretched with a relatively large tension and stably fixed.
(9) The part of the string-through-body hole 53 supported by the saddle 70 includes the rounded portion 53a. That part is in contact with the intermediate portion 90d of the string 90 in which the rear end 90b is fixed to the string-rear-end fixing portion 41. The curvature of the rounded portion 53a is set to the value at which the string 90 does not bend beyond the predetermined curvature at the part where the string 90 is in contact with the wall of the string-through-body hole 53. Accordingly, even when the stretching direction of the string 90 is changed at a relatively large angle, the string 90 is unlikely to be damaged or degraded.
(10) The tailpiece 80 has a substantially cylindrical shape. The tailpiece 80 includes the string introduction groove 81, which extends in the stretching direction of the string 90. This allows the string 90 to be introduced into the tailpiece 80 through the string introduction groove 81 and thus facilitates stretching of the string 90.
(11) The tailpiece 80 includes the string-rear-end fixing portion 83, which hooks the rear end 90b of the string 90 in a state where the string 90 supported by the saddle 70 is introduced from the string introduction groove 81. This configuration also facilitates stretching of the string 90.
(12) The saddle 70 is accommodated in the cavity 71 of the base unit 60 so as to be slidable in the string height direction. The saddle 70 includes the two string height adjustment screw holes 73. The two string height adjustment screws 72 are threaded into the string height adjustment screw holes 73 from above, respectively. Each string height adjustment screw 72 has the front end that protrudes from the lower end of the saddle 70 to bring the front end into contact with the bottom surface of the cavity 71, thereby maintaining the height of the saddle 70. The string height can be adjusted by turning the string height adjustment screw 72. This arrangement facilitates adjustment of the string height while keeping the string 90 stretched.
(13) The two string height adjustment screws 72 are provided such that the string 90 is disposed therebetween. This arrangement allows the string height of the stretched string 90 to be adjusted without interference with the saddle 70.
(14) The saddle fixing screw 74 is threaded into the saddle fixing screw hole 75 in the direction that is orthogonal to the sliding direction of the saddle 70. By fastening the saddle fixing screw 74 to the saddle fixing screw hole 75, the sliding of the saddle 70 in the cavity 71 is restricted. This enables the adjusted string height to be maintained.
(15) The saddle 70 is made of metal having higher slidability than the base unit 60. This prevents the string 90 from deteriorating due to friction with the saddle 70 when the string 90 is stretched or when the intonation of the string 90 is adjusted.
(16) The saddle 70 slides on a surface of the base unit 60, the surface defining the cavity 71 and being annular as viewed in the sliding direction of the saddle 70. Thus, when the string height adjustment is completed and then the saddle fixing screw 74 is tightened and fixed, the saddle 70 is stably accommodated in the cavity 71 without rattling.
(17) The bridge 5 is one of multiple bridges, each corresponding to a respective string 90. This provides greater flexibility in setting parameters such as the string length for each string 90.
(18) The base unit 60 includes the side wall 66, which is located between the cavity 71 and the tailpiece 80. The side wall 66 extends in the longitudinal direction of the string passage hole 61 and the string height direction. This enables the strength of the base unit 60 to be set to a level sufficient to withstand the tension of the string 90.
(19) The base plate 50 is accommodated in the bridge accommodation portion 4a, which is provided in the body 4 and is a recess having a depth in the string height direction. The bridge accommodation portion 4a has a shape conforming to the contour of the base plate 50 as viewed in the string height direction. This prevents the bridge 5 from protruding from the front surface of the body 4. Further, the strength of the bridge 5 is enabled to be set to a level sufficient to withstand the tension of the string 90.
(20) The stringed instrument of the present disclosure is a multi-string electric guitar having seven strings, but is not limited to the electric guitar. The advantages of the present disclosure are exhibited in electric basses, particularly in multi-string electric basses having five or more strings.

### MODIFICATIONS

The present disclosure is not limited to the present embodiment, and may be implemented in various other forms.

The sliders 62 may be provided on the base plate 50, and the slide rails 51 may be provided on the base unit 60.

The slide rails 51 and the sliders 62 may have any configuration as long as they allow the base unit 60 to slide in the stretching direction of the string 90.

The saddle 70 may be integrally formed with the base unit 60.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. A stringed instrument, comprising:
a body;
a string supported by the body;
a string-rear-end fixing portion provided on the body and configured to fix a rear end of the string;
a bridge including a base plate fixed to the body and a base unit provided on the base plate so as to be slidable in a stretching direction of the string;
a saddle accommodated in a cavity provided in the base unit, the saddle being configured to support the string;
a string height adjustment mechanism configured to adjust raising and lowering of the saddle; and
an intonation adjustment mechanism configured to slide the base unit on the base plate in the stretching direction, wherein
the base plate includes a string-through-body hole through which the string, supported by the saddle, is drawn into the string-rear-end fixing portion of the body,
the base unit includes a string passage hole that allows the string, supported by the saddle, to pass through the string-through-body hole, and
the base unit includes a tailpiece configured to fix a rear end of the string, and the base unit is configured to fix the rear end of the string instead of the string-rear-end fixing portion.

2. The stringed instrument according to claim 1, wherein
the string passage hole is shaped as an elongated hole that extends in the stretching direction such that the string does not interfere with a wall of the string passage hole when the base unit is slid relative to the base plate.

3. The stringed instrument according to claim 1, wherein
the intonation adjustment mechanism includes a slide rail and a slider that are provided on the base plate and the base unit, respectively,
the intonation adjustment mechanism is configured to slide the base unit in the stretching direction relative to the base plate,
the base unit includes a guide groove that extends in the stretching direction,
the base plate includes a base-unit-fixing screw hole,
a shaft of a base-unit-fixing screw is threaded into the base-unit-fixing screw hole, the shaft of the base-unit-fixing screw is guided by the guide groove, and
the base unit is configured to be restricted from moving in the stretching direction relative to the base plate by fastening the base-unit-fixing screw.

4. The stringed instrument according to claim 3, wherein
the slider is provided so as to surround a peripheral edge of the string passage hole.

5. The stringed instrument according to claim 1, wherein
the string-rear-end fixing portion is configured to fix the rear end of the string introduced from a rear surface of the body.

6. The stringed instrument according to claim 1, wherein
a part of the string-through-body hole supported by the saddle includes a rounded portion, the part being in contact with an intermediate portion of the string in which the rear end is fixed to the string-rear-end fixing portion, and
the rounded portion has a curvature that is set to a value at which the string does not bend beyond a predetermined curvature at a part of the rounded portion where the string is in contact with a wall of the string-through-body hole.

7. The stringed instrument according to claim 1, wherein
the tailpiece is cylindrical, and includes a string introduction groove extending in the stretching direction.

8. The stringed instrument according to claim 7, wherein
the tailpiece includes a ball end hooking portion configured to hook a rear end of the string in a state in which the string supported by the saddle is introduced from the string introduction groove.

9. The stringed instrument according to claim 1, wherein
in the string height adjustment mechanism, the saddle is accommodated in the cavity of the base unit so as to be slidable in a string height direction, and
the saddle includes a string height adjustment screw hole,
a string height adjustment screw is threaded into the string height adjustment screw hole from above,
the string height adjustment screw has a front end that protrudes from a lower end of the saddle to maintain a height of the saddle, and
a string height is adjusted by turning the string height adjustment screw.

10. The stringed instrument according to claim 9, wherein
the string height adjustment screw is one of two string height adjustment screws, and
the two string height adjustment screws are provided such that the string is disposed between the two string height adjustment screws.

11. The stringed instrument according to claim 9, further comprising a saddle fixing screw, wherein
the saddle is configured to be restricted from sliding by turning the saddle fixing screw threaded into the saddle fixing screw hole in a direction that is orthogonal to a sliding direction of the saddle.

12. The stringed instrument according to claim 9, wherein
the saddle is made of metal having higher slidability than the base unit.

13. The stringed instrument according to claim 9, wherein
the saddle slides on a surface of the base unit, the surface defining the cavity and being annular as viewed in a sliding direction of the saddle.

14. The stringed instrument according to claim 1, wherein
the string is one of multiple strings,
the bridge is one of multiple bridges, and
each of the bridges is provided for a corresponding one of the strings.

15. The stringed instrument according to claim 1, wherein
the base unit includes a side wall that is located between the cavity and the tailpiece, and
the side wall extends in a longitudinal direction of the string passage hole and a string height direction.

16. The stringed instrument according to claim 1, wherein
the base plate is accommodated in a bridge accommodation portion provided in the body, the bridge accommodation portion including a recess that has a depth in a string height direction, and
the bridge accommodation portion has a shape conforming to a contour of the base plate as viewed in the string height direction.

17. The stringed instrument according to claim 1, wherein
the stringed instrument is an electric guitar or an electric bass.

18. The stringed instrument according to claim 17, wherein
the string is one of multiple strings, and the number of the strings included in the electric guitar is seven or more.

19. The stringed instrument according to claim 17, wherein
the string is one of multiple strings, and the number of the strings included in the electric bass is five or more.
